(19) United States
(12) Patent Application Publication
(10) Pub. No.: US 2014/0347774 A1
(43) Pub. Date: Nov. 27, 2014

(54) OVERCURRENT PROTECTION CIRCUIT, AND ELECTRONIC CONTROL UNIT

(71) Applicant: TOYOTA JIDOSHA KABUSHIKI KAISHA, Toyota-shi (JP)

(72) Inventor: Manabu UEHARA, Toyota-shi (JP)

(73) Assignee: TOYOTA JIDOSHA KABUSHIKI KAISHA, Toyota-shi (JP)

(21) Appl. No.: 14/262,229

(22) Filed: Apr. 25, 2014

(30) Foreign Application Priority Data
May 22, 2013 (JP) 2013-108252

(51) Int. Cl. H02H 9/02

(52) U.S. Cl. CPC H02H 9/025
USPC 361/87

(57) ABSTRACT

An overcurrent protection circuit that protects a load from an overcurrent includes: a load current cutoff condition defining unit configured to set two or more load current cutoff conditions in each of which passage of a load current larger than or equal to a specified current for a specified time or longer is set as a condition for cutting off the load current; a detection unit configured to detect passage of the load current larger than or equal to the specified current for the specified time or longer in at least one of the two or more load current cutoff conditions; and a load current cutoff unit configured to cut off the load current when the detection unit detects that at least one of the load current cutoff conditions is satisfied.

### INCORPORATION BY REFERENCE

The disclosure of Japanese Patent Application No. 2013-108252 filed on May 22, 2013 including the specification, drawings and abstract is incorporated herein by reference in its entirety.

### BACKGROUND OF THE INVENTION

1. Field of the Invention

The invention relates to an overcurrent protection circuit, and the like, that protect a load from an overcurrent.

2. Description of Related Art

The type and number of electrically controlled loads are increasing, and further highly accurate current monitoring is desired. In order to protect various electrical circuits and substrates from a large current larger than or equal to a rated value and prevent overheating, or the like, a fuse (chip fuse) may be arranged. The fuse blows out in a blowout time based on a current value when a current larger than a rated current flows, thus preventing flow of overcurrent.

FIG. 1 is a graph that shows an example of a fuse characteristic. The correlation between a load current and a blowout time is shown; however, numeric values are one example. When current flows through the fuse, the temperature of a fuse film increases due to Joule heat, and the fuse starts melting when the temperature of the fuse film reaches a melting temperature, and finally blows out to interrupt load current. Therefore, a certain period of time is required for the fuse to blow out, and the fuse has such a characteristic that the blowout time becomes shorter as the load current increases as shown in the graph. Such a characteristic is advantageous in that a fuse does not blow out when overcurrent temporarily flows through a load due to noise, or the like, and it is possible to reliably interrupt a large load current when the load current flows.

However, a fuse cannot recover when once blows out, so a fuse makes it difficult to repair a substrate, or the like. It is also required to select a fuse having an appropriate blowout time, so there is a technique for preventing flow of overcurrent with the use of a circuit without using a fuse (for example, see Japanese Patent Application Publication No. 09-308261 (JP 09-308261 A)). An overcurrent protection circuit described in JP 09-308261 A operates as follows.

When detection means detects an overcurrent larger than or equal to a predetermined current value and flowing through a switching element, protection means forcibly turns off the switching element for a predetermined protection time. Frequency monitoring means monitors the frequency at which the protection means turns off the switching element, and keeps the off state by forcibly turning off the switching element when the frequency becomes larger than or equal to a predetermined frequency. This inhibits a situation that it is not possible to drive an electrical load in the case where an overcurrent temporarily flows through a load due to noise, or the like.

However, the overcurrent protection circuit described in JP 09-308261 A eventually just turns off the switching element when a load current larger than or equal to a set predetermined current value is detected, and there is an inconvenience that circuit protection may be insufficient.

FIG. 2A and FIG. 2B are examples of graphs that illustrate the inconvenience of the existing art. Numeric values of FIG. 2A and FIG. 2B are one example. A nondestructive region and a cutoff region are shown in each of FIG. 2A and FIG. 2B. The nondestructive region is a rectangular region that is defined by current and time, and is a region in which a load may not be destructed. The nondestructive region may be termed a region in which a current smaller than or equal to the rated current flows. In FIG. 2A and FIG. 2B, the nondestructive region is a region smaller than 5 A. The cutoff region is a region that is defined by current and time and in which a load current flowing through a load should be cut off.

The cutoff region in FIG. 2A schematically shows the fact that a load current is cut off when the load current higher than or equal to 40 A has flowed for 5 ms or longer. However, in the thus defined cutoff region, if a load current (5 [A] in the drawing) slightly larger than the nondestructive region continuously flows, it is not possible to cut off the load current.

The cutoff region in FIG. 2B schematically shows that a load current is cut off when a load current larger than or equal to 5 A has flowed for 500 ms or longer. However, in the thus defined cutoff region, if a load current (40 [A] in the graph) larger than the nondestructive region flows only in a short period of time, it is not possible to cut off the load current.

Thus, when a cutoff region is determined by using a certain set of load current and time as shown in FIG. 2A and FIG. 2B, there is an inconvenience that the circuit may not be protected.

### SUMMARY OF THE INVENTION

The invention provides a load current protection circuit that appropriately protects a load from an overcurrent.

A first aspect of the invention provides an overcurrent protection circuit that protects a load from an overcurrent. The overcurrent protection circuit includes: a load current cutoff condition defining unit configured to define two or more load current cutoff conditions in each of which passage of a load current larger than or equal to a specified current for a specified time or longer is set as a condition for cutting off the load current; a detection unit configured to detect passage of the load current larger than or equal to the specified current for the specified time or longer in at least one of the two or more load current cutoff conditions; and a load current cutoff unit configured to cut off the load current when the detection unit detects that at least one of the load current cutoff conditions is satisfied.

According to the above aspect, it is possible to provide the load current protection circuit that appropriately protects a load from an overcurrent.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a graph that shows an example of a fuse characteristic;

FIG. 2A and FIG. 2B are examples of graphs that illustrate an inconvenience of the existing art;

FIG. 3A and FIG. 3B are examples of views that show an overcurrent protection circuit according to an embodiment of the invention;

FIG. 4 is an example of a view that schematically illustrates an overcurrent protection circuit implemented in an ECU of a vehicle;

FIG. 5 is a configuration view of an overcurrent protection circuit according to a first example embodiment of the invention;

FIG. 6 is an example of a view that illustrates operations of the overcurrent protection circuit according to the first example embodiment in flowchart;

FIG. 7 is a configuration view of an overcurrent protection circuit according to a second example embodiment of the invention;

FIG. 8 is a view that shows an example of a logic circuit for a counter 1 to measure a counting time in the case of a load current larger than or equal to 5 [A];

FIG. 9 is a configuration view of an overcurrent protection circuit according to a third example embodiment of the invention;

FIG. 10 is a view that shows an example of a demultiplexer according to the third example embodiment; and

FIG. 11A and FIG. 11B are an example of a view that illustrates operations of the overcurrent protection circuit according to the third example embodiment in flowchart.

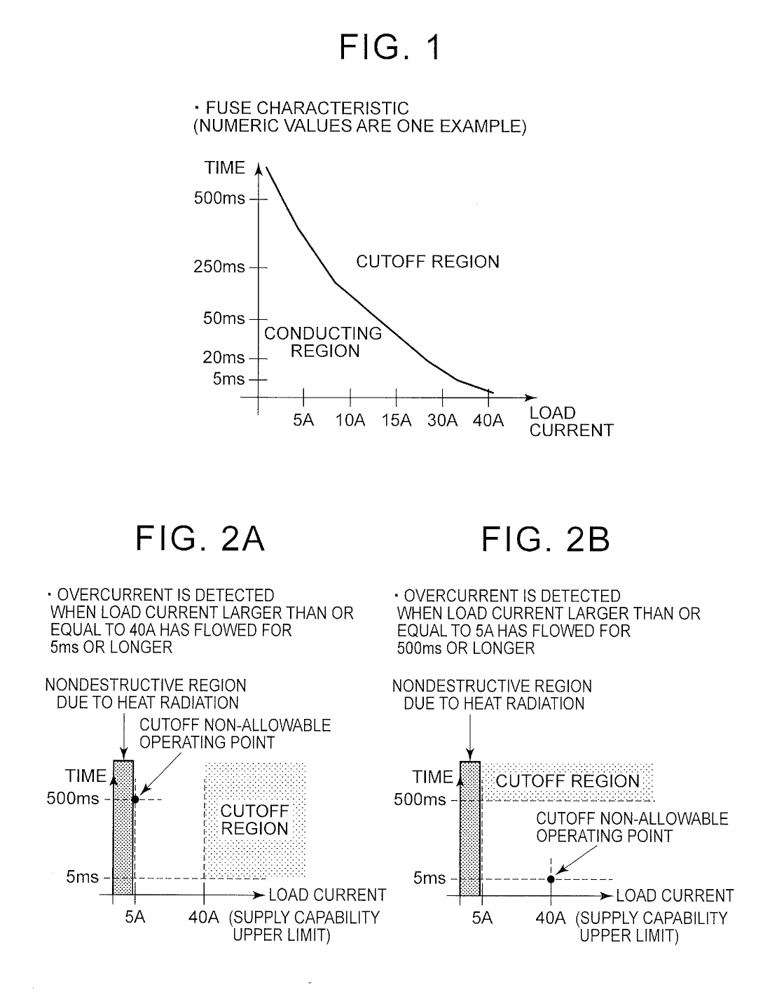

### DETAILED DESCRIPTION OF EMBODIMENTS

Hereinafter, an embodiment of the invention will be described by way of example embodiments with reference to the accompanying drawings.

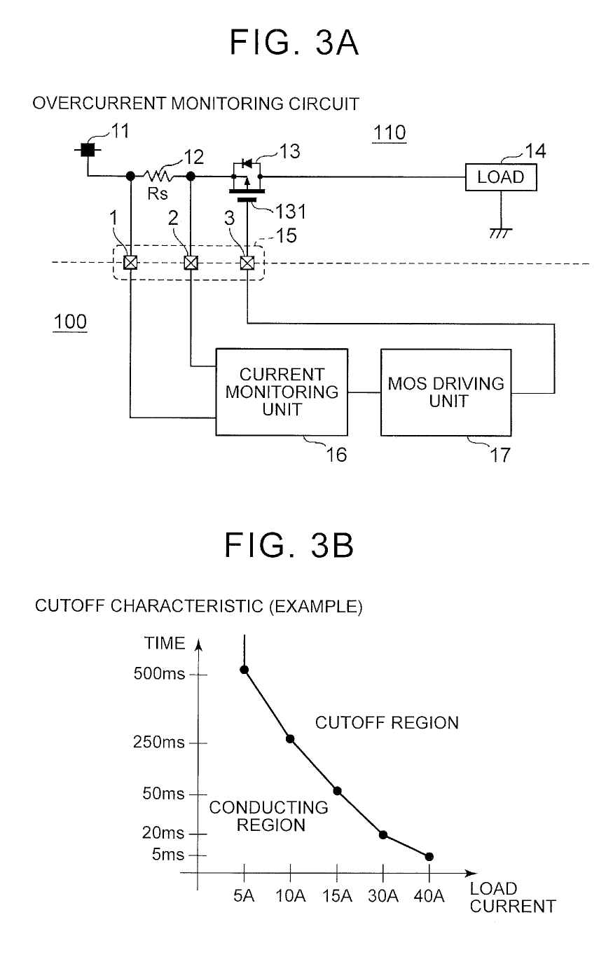

FIG. 3A and FIG. 3B are examples of views that illustrate an overcurrent protection circuit according to the present embodiment. FIG. 3A shows an example of a circuit configuration. FIG. 3B shows an example of a cutoff characteristic. A monitored circuit 110 and the overcurrent protection circuit 100 are connected to each other by terminals 15. In the monitored circuit 110, a shunt resistor 12 for monitoring a load current and a MOS switch 13 that cuts off the load current are arranged in series with each other between a power supply 11 and a load 14. A current monitoring unit 16 and a MOS driving unit 17 are arranged in the overcurrent protection circuit 100. The current monitoring unit. 16 is connected in parallel with the shunt resistor 12, and the MOS driving unit 17 is connected to the MOS switch 13.

A plurality of operating points for cutting off the load current are defined in the current monitoring unit 16. Each of the operating points is a threshold at which the MOS driving unit 17 cuts off a load current when the load current larger than or equal to a specified current has flowed for a specified time or longer. A plurality of selected operating points may be defined. FIG. 3B is an example of a cutoff region having a similar shape to that of the fuse characteristic. The power supply monitoring unit functions as a load current cutoff condition defining unit and a detection unit according to the invention.

The detailed configuration of the current monitoring unit 16 will be described later in first to third example embodiments, and the outlines of them are as follows.

(i) A plurality of comparators and counters in the same number as the comparators are arranged in the current monitoring unit 16, and each counter counts a period of time when a corresponding one of the comparators detects a load current larger than or equal to a corresponding specified current. When the counted time of at least one of the counters reaches the corresponding specified time, the MOS driving unit 17 turns off the MOS switch 13 (first example embodiment).

(ii) An A/D converter is arranged in the current monitoring unit 16, and a load current flowing through the shunt resistor 12 is detected. When the magnitude of the load current exceeds a specified current, the corresponding counter counts a period of time. When the period of time counted by at least one of the counters reaches a corresponding specified time, the MOS driving unit 17 turns off the MOS switch 13 (second example embodiment). (iii) The current monitoring unit 16 that is able to change a specified current is arranged. When the fact that a load current exceeds a specified current is detected by a comparator, the counter corresponding to the load current counts a period of time. The specified current that is detected by the comparator is changed each time the load current exceeds the specified current. When at least one of the counters reaches a corresponding specified time, the MOS driving unit 17 turns off the MOS switch 13 (third example embodiment).

A plurality of operating points arc allowed to be selectively defined in any one of the example embodiments, so it is possible to inhibit occurrence of a region (specified by current and time) in which a load cannot be protected. By increasing the density of the operating points, it is possible to appropriately protect a load by accurately detecting an overcurrent.

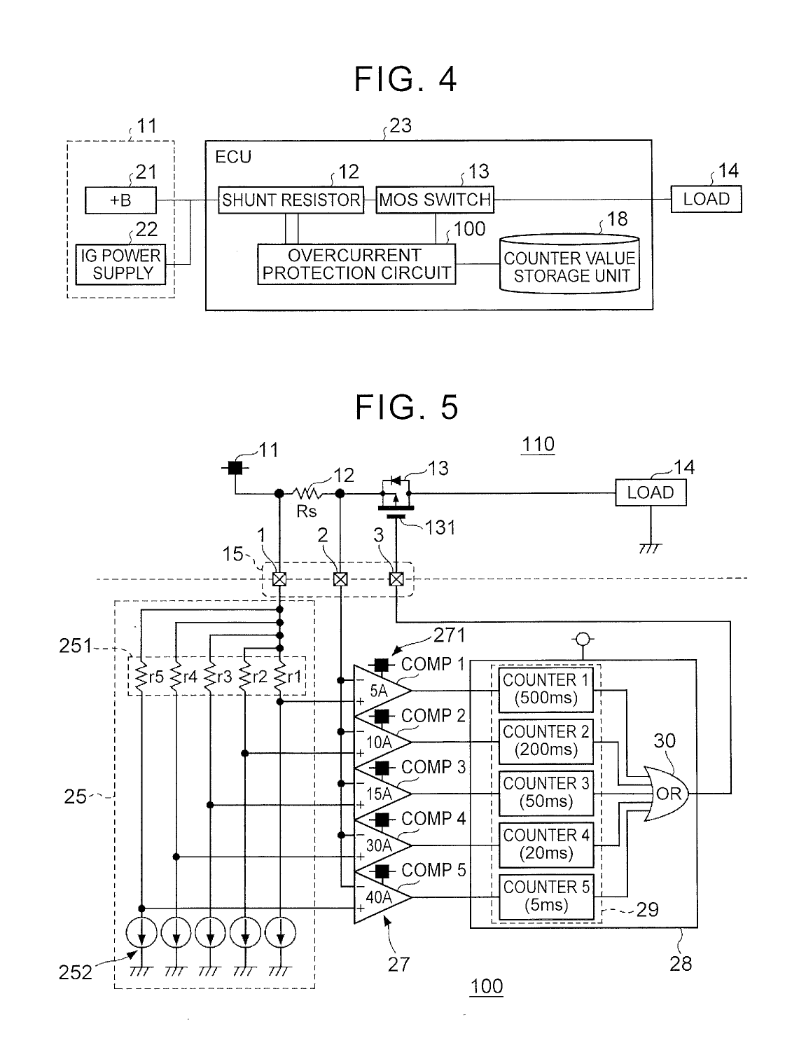

The first example embodiment will be described. FIG. 4 is an example of a view that schematically illustrates the overcurrent protection circuit 100 implemented in an ECU of a vehicle. Various electronic control units (ECUs) 23 are mounted on the vehicle, and each of the ECUs provides a specific function. For example, there are many ECUs, such as an ECU that controls AV, a navigation system, and the like, an electric power steering ECU that controls an electric power steering, a headlight ECU that controls headlights, a window ECU that opens or closes door windows, a meter ECU that controls indication of a meter panel, and a body ECU that executes control for turning on lights in a vehicle cabin, detects open/close of each door, and the like. Thus, the loads 14 connected to the ECUs include various devices, such as a speaker of audio, a motor that drives a steering shaft and light sources of the headlights.

Each ECU 23 operates on a battery (+B power supply) 21 or an IG power supply (a power supply is the same battery) 22, and electric power is also supplied to the corresponding load 14 from the battery 21. The overcurrent protection circuit 100 according to the present embodiment is suitably implemented in each ECU 23 that controls the load 14 that operates on the battery 21 in this way.

The ECU 23 includes a counter value storage unit 18. A counter value set in a counter (described later) is stored in the counter value storage unit 18 in correspondence with a specified current. The CPU of the ECU 23 loads the counter value from the counter value storage unit 18 at the time of start-up and sets the loaded counter value in a register, or the like, of the counter.

The correspondence between the counter value and the magnitude of the specified current does not need to be fixed, and a set counter value may be changed in response to a situation, or the like. For example, when an overcurrent is detected during one trip, the counter value that is set for the corresponding specified current is reduced. When the ambient temperature is higher than or equal to a threshold, the counter value that is set for the corresponding specified current is reduced; whereas, when the ambient temperature is lower than the threshold, the counter value is increased.

The overcurrent protection circuit 100 is not only applicable to each ECU 23 of the vehicle but also suitably implemented between the power supply 11 and the load 14 that is driven by the power supply 11 in mainly a device, such as a microcomputer, a printed board, an electronic circuit and an electrical circuit.

FIG. 5 shows an example of a configuration view of the overcurrent protection circuit 100 according to the present example embodiment. The monitored circuit 110 is shown on the upper side of the dashed line in FIG. 5. As described above, the shunt resistor 12 of a resistance value Rs and the MOS switch 13 are connected in series with each other between the power supply 11 and the load 14. The MOS switch 13 is of a P type in the drawing. Thus, when an input to a gate 131 is Low(0), the MOS switch 13 supplies a load current to the load 14; whereas, when an input to the gate 131 is Hi(1), the MOS switch 13 cuts off the load current. The MOS switch 13 may be of an N type or a switch element other than an MOS may also be used.

In FIG. 5, a portion on the lower side of the dashed line is the overcurrent protection circuit 100. The overcurrent protection circuit 100 is, for example, implemented in a form, such as an IC. Both ends of the shunt resistor 12 are respectively connected to the terminals 1, 2 of the terminals 15 (hereinafter, referred to as terminals 1 to 3 for distinguishing from one another) of the, overcurrent protection circuit 100. Thus, as will be described later, the voltage between both ends of the shunt resistor 12 is input to each comparator 27.

A reference voltage generating unit 25 is connected to the terminal 1. The reference voltage generating unit 25 includes at least a plurality of reference voltage resistors 251 that are connected in parallel with each other. Hereinafter, the reference voltage resistors 251 are respectively referred to as reference voltage resistors r1 to r5 by using corresponding resistance values r1 to r5. Because the reference voltage resistors r1 to r5 respectively have different resistance values, specified currents in the number of the reference voltage resistors are allowed to be defined (the same resistance values of the reference voltage resistors are allowed).

End portions of the reference voltage resistors r1 to r5 on the side opposite to the terminal 1 are respectively connected to the comparators (hereinafter, referred to as comparators 1 to 5 for distinguishing from one another, and are indicated by COMP1 to COMPS in FIG. 5) 27. That is, the reference voltage resistor r1 is connected to the input terminal in+ of the comparator 1, the reference voltage resistor r2 is connected to the input terminal in+ of the comparator 2, the reference voltage resistor r3 is connected to the input terminal in+ of the comparator 3, the reference voltage resistor r4 is connected to the input terminal in+ of the comparator 4, and the reference voltage resistor r5 is connected to the input terminal in+ of the comparator 5. Thus, the voltage of the power supply 11 is stepped down by the reference voltage resistors r1 to r5 and then input to the input terminals in+ of the comparators 1 to 5.

The reference voltage resistors r1 to r5 are connected to a ground via current sources (hereinafter, referred to as current sources 1 to 5 for distinguishing from one another) 252. The current sources 252 are ideal power supplies that constantly pass a constant current (extremely small).

On the other hand, the voltage of the power supply 11 is stepped down by the resistance value Rs of the shunt resistor 12 and then input to the input terminals in− of the comparators 1 to 5. Thus, each of the comparators 1 to 5 outputs a value of a positive power supply 271 (that is, a Hi-level signal) in the case where “input terminal in+ input terminal in−”, and outputs zero [V] in the case where “input terminal in+≦input terminal in−”.

Thus, in order for each comparator 27 to detect the corresponding specified current, the values of the reference voltage resistors r1 to r5 should be determined as follows. Focusing on the comparator 1, because the comparator 1 is connected to the two resistors Rs, r1 connected in parallel with the same power supply 11, a current I flowing through the shunt resistor Rs may be expressed as follows (V denotes the voltage of the power supply 11).

I=V/Rs=Vr1

Thus, r1 in the case where the specified current (for example, 5 A) is set for I is obtained, and the resultant value should be used as the resistance value of the reference voltage resistor r1.

Similarly, the reference voltage resistors r2 to r5 are also allowed to be determined on the basis of a selected specified current and the voltage of the power supply 11. In the present embodiment, the reference voltage resistors r1 to r5 respectively having the specified currents of 5, 10, 15, 30, 40 [A] are defined.

As the number of the reference voltage resistors r1 to r5 increases, the cutoff region is allowed to be more strictly defined. The number of the reference voltage resistors r1 to r5 is desirably larger than or equal to two, and a required number should be determined on the basis of for example, reliability that is required for the load 14 to which a load current is supplied.

A digital circuit 28 is arranged downstream of the comparators 27. The digital circuit 28 operates on a predetermined voltage (for example, 5 V) to which the voltage of the power supply 11 is stepped down. The outputs of the comparators 1 to 5 are respectively connected to counters (hereinafter, referred to as counters 1 to 5 for distinguishing from one another) 29 of the digital circuit 28. Each counter 29 has a predetermined overflow value. In the present embodiment, the counter 1 having an overflow value of 500 [ms] is connected to the comparator 1, the counter 2 having an overflow value of 200 [ms] is connected to the comparator 2, the counter 3 having an overflow value of 50 [ms] is connected to the comparator 3, the counter 4 having an overflow value of 20 [ms] is connected to the comparator 4, and the counter 5 having an overflow value of 5 [ms] is connected to the comparator 5. These overflow values define specified times.

That is, the comparator 27 that defines a larger specified current is connected to the counter 29 having a shorter specified time, so it is possible to reproduce the fuse characteristic. However, the correlation between a specified current that is defined by the comparator 27 and a specified time that is defined by the counter 29 may be selected, and the overflow values of the counters do not need to be totally different from one another. A plurality of counters may define the same specified time, or a comparator B that defines a specified current larger than that of a comparator A may be connected to a counter that defines a specified time longer than that of a counter connected to the comparator A.

Each of the counters 1 to 5 counts a period of time only while the Hi signal is input from a corresponding one of the comparators 1 to 5. The counters 1 to 5 are connected to the input side of an OR circuit 30. When each of the counters 1 to 5 counts a period of time up to the corresponding overflow value, each of the counters 1 to 5 outputs the Hi (on) signal to the OR circuit 30. The output of the OR circuit 30 is connected to the MOS switch 13. Thus, when at least one of the counters 1 to 5 outputs the Hi signal, the OR circuit 30 outputs the Hi signal to the gate 131 of the MOS switch 13. Thus, the MOS switch 13 cuts off the load current.

Each of the counters 1 to 5 interrupts counting a period of time when the Hi signal is not input from a corresponding one of the comparators 1 to 5 anymore while counting a period of time up to the corresponding overflow value. When the Hi signal is input from the corresponding one of the comparators 1 to 5 again before a set period of time (for example, 2 [ms]) elapses, the corresponding one of the counters 1 to 5 resumes counting from the interrupted period of time. When the set period of time elapses, the corresponding one of the counters 1 to 5 initializes the period of time counted up to the interruption. Thus, when a load current larger than or equal to the specified current of any one of the comparators 1 to 5 flows due to noise, or the like, it is possible to suppress overflow. The set period of time may be the same among the comparators 1 to 5 or may be different among the comparators 1 to 5. For example, by setting like “several percent of the overflow value”, it is possible to reduce a period of time up to initialization as the specified time reduces.

The operation of the overcurrent protection circuit 100 will be simply described. First, electric power is supplied from the power supply 11 to the load 14. Subsequently, when a current value that is supplied to the load 14 becomes larger than or equal to 5 [A] (smaller than 10 [A]), the comparator 1 detects the load current larger than or equal to the corresponding specified current on the basis of the voltage between both ends of the shunt resistor 12. The counter I starts counting a period of time. The load current becomes smaller than 5 [A] before the counter 1 counts 500 [ms], the counter 1 ends counting a period of time. Thus, the MOS switch 13 does not cut off the load current. In this case, the overcurrent protection circuit 100 resumes monitoring. When the counter 1 has counted up to 500 [ms], the MOS switch 13 cuts off the load current. Thus, the operation of the load 14 becomes difficult; however, it is possible to protect the load 14 from an overcurrent.

The overcurrent protection circuit 100 stores the diagnosed result that the overcurrent is detected, in a nonvolatile memory. By alarming an occupant by, for example, blinking of an abnormality lamp of the meter panel, the occupant is allowed to take action, such as driving the vehicle to a dealer. A serviceman at the dealer loads the diagnosed result from the ECU with the use of a tool, or the like, so the serviceman is allowed to recognize that overcurrent is detected.

The P-type MOS switch 13 is turned on when an IG switch (a main switch in the case of a hybrid vehicle or an electric vehicle) is turned off. That is, even after the MOS switch 13 is turned off to cut off the load current, the MOS switch 13 is turned on when the IG switch is turned on the next time, so the power supply 11 is allowed to supply electric power to the load 14.

The counter connected to the comparator that defines a smaller specified current does not always overflow first. In addition, the counter that defines a shorter specified time does not always overflow first. For example, when 400 [ms] has elapsed after the load current becomes larger than or equal to 5 [A] (smaller than 10 [A]) and then the load current becomes larger than or equal to 10 [A] (smaller than 15 [A]), the counter 1 overflows the earliest at the timing at which the counter 1 has further counted 100 [ms]. On the other hand, when the load current suddenly becomes larger than or equal to 10 [A] (smaller than 15 [A]) and 200 [ms] has elapsed, the counter 2 overflows the earliest at the timing at which the counter 2 has counted 200 [ms]. In this way, detection of an overcurrent by which one of the specified currents and which one of the specified times can vary on the basis of the specified currents, the specified times and the magnitude of the load current.

### Operation Procedure

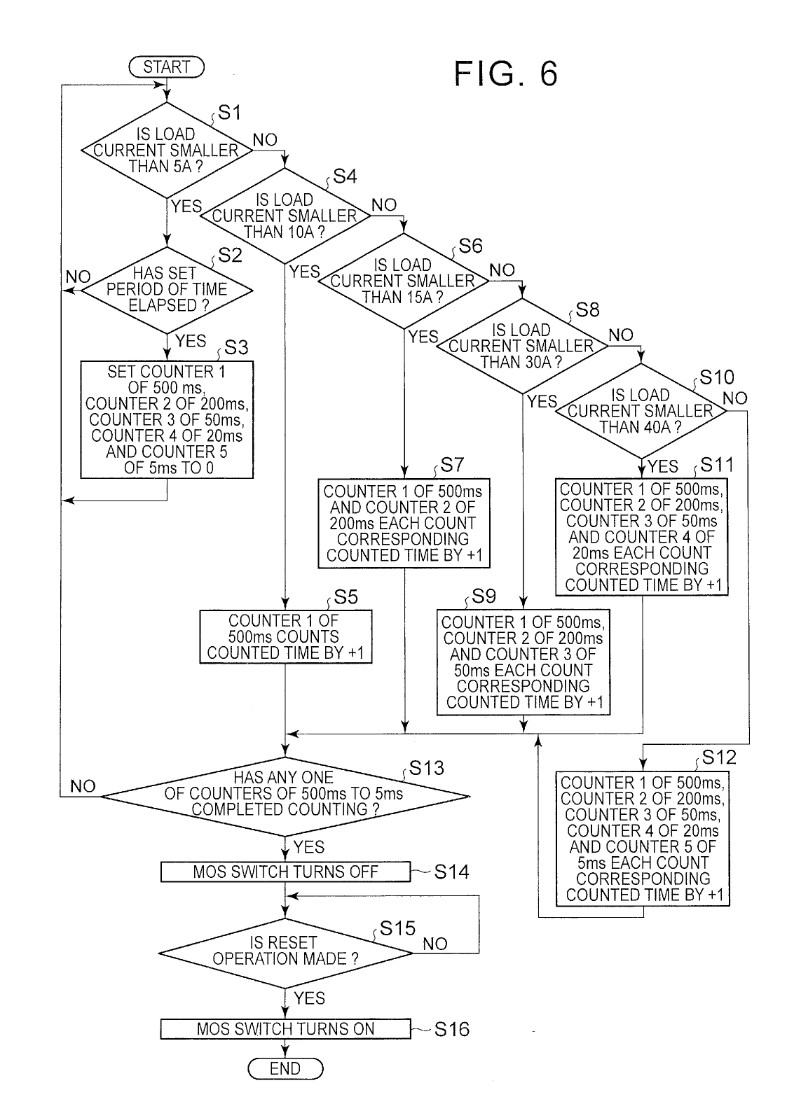

FIG. 6 is an example of a view that illustrates operations of the overcurrent protection circuit 100 in flowchart. When the load current is smaller than 5 [A] (Yes in S1), after a set period of time elapses (Yes in S2), the digital circuit 28 sets the counted times of the counters 1 to 5 to zero (S3). That is, no overcurrent is detected, so the counted times are initialized.

When the load current is larger than or equal to 5 [A] (No in S1) and the load current is smaller than 10 [A] (Yes in S4), the counter 1 counts a counted time by “+1” (S5). That is, only the counter 1 counts a period of time.

When the load current is larger than or equal to 10 [A] (No in S4) and the load current is smaller than 15 [A] (Yes in S6), the counter 1 and the counter 2 each count a corresponding counted time by “+1” (S7). That is, only the counters 1, 2 count a period of time.

When the load current is larger than or equal to 15 [A] (No in S6) and the load current is smaller than 30 [A] (Yes in S8), the counters 1 to 3 each count a corresponding counted time by “+1” (S9). That is, the counters 1 to 3 count a period of time.

When the load current is larger than or equal to 30 [A] (No in S8) and the load current is smaller than 40 [A] (Yes in S 10), the counters 1 to 4 each count a corresponding counted time by “+1” (S 11). That is, the counters 1 to 4 count a period of time.

When the load current is larger than or equal to 40 [A] (No in S10), the counters 1 to 5 each count a corresponding counted time by “+1” (S12). That is, all the counters 1 to 5 count a period of time.

When at least any one of the counters 1 to 5 completes counting up to the corresponding specified time (Yes in S13), the MOS switch 13 turns off (S14). When all the counters 1 to 5 have not counted up to the corresponding specified times (No in S13), the overcurrent protection circuit 100 repeats the counting process of S1 to S12.

When the IG switch is turned on or the microcomputer is reset (Yes in S15), the MOS switch 13 turns on (S16).

As described above, the overcurrent protection circuit 100 according to the present example embodiment is able to selectively define a plurality of operating points, so it is possible to inhibit occurrence of an operating point at which the circuit cannot be protected.

In the second example embodiment, the overcurrent protection circuit 100 that detects an overcurrent with the used of the A/D converter will be described.

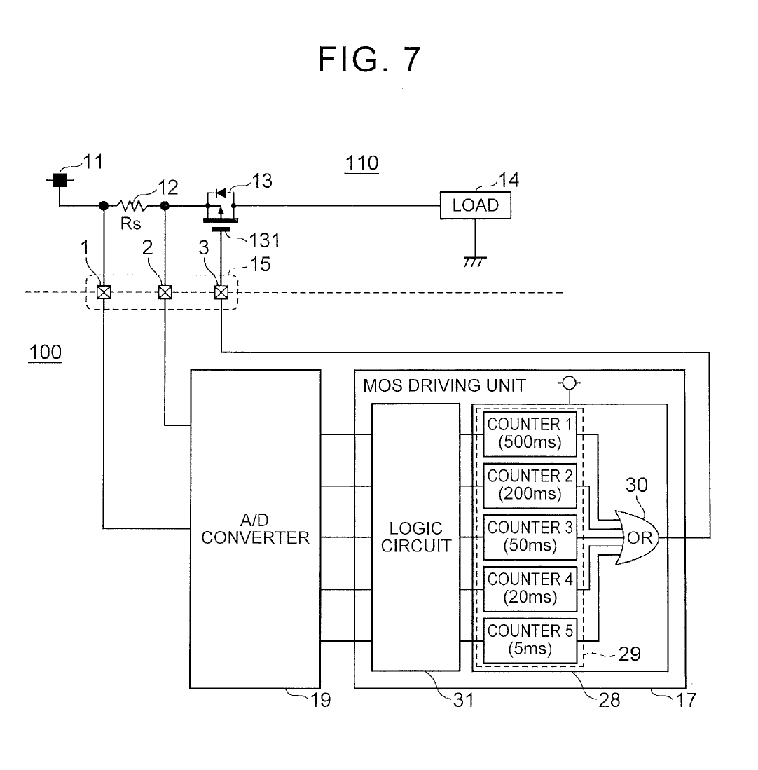

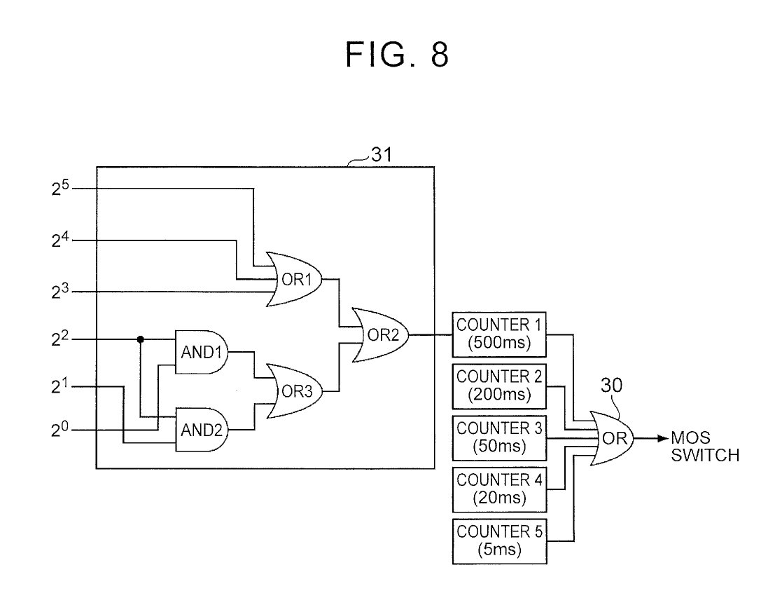

FIG. 7 shows an example of a configuration view of the overcurrent protection circuit 100 according to the present example embodiment. In FIG. 7, components indicated by like reference numerals as those of FIG. 5 exhibit similar functions, so only the major components of the present example embodiment may be specifically described.

The terminals 1, 2 of the overcurrent protection circuit 100 are connected to the A/D converter 19. Thus, the voltage between both ends of the shunt resistor 12 is analog/digital-converted by the A/D converter 19. For example, the following load current is converted to the following digital signal (binary).

5 [A] is converted to 101, 10 [A] is converted to 1010, 15 [A] is converted to 1111, 30 [A] is converted to 1110, and 40 [A] is converted to 10100. The A/D converter 19 has bit terminals that output “1” or “0” at each digit of the binary, and outputs a signal of “1” or “0” from each terminal on the basis of the converted result. This signal is output to the MOS driving unit 17. Actually, the voltage between both ends of the shunt resistor is A/D-converted; however, the current value may be directly A/D-converted.

The MOS driving unit 17 has a logic circuit 31. The logic circuit 31 includes digital circuits, such as AND circuits, OR circuits, NOT circuits and XOR circuits, and detects that a load current is larger than or equal to specified currents with the use of a combination of these. When the load current larger than or equal to at least one of the specified currents is detected, a corresponding one of the counters 1 to 5 is informed, and the corresponding one of the counters 1 to 5 counts a corresponding counted time. Here, the logic circuit 31 functions as a time counting control unit according to the invention.

FIG. 8 is an example of the logic circuit 31 for the counter 1 to count a counted time in the case of the load current larger than or equal to 5 [A]. The binary of 5 [A] is “101”, so the digit of 2° is 1, the digit of 2¹ is 0, and the digit of 2² is 1. Thus, the fact that both the digit of 2° and the digit of 2² are 1 is detected. “110” is also larger than or equal to 5 [A], so both the digit of 2¹ and the digit of 2² are 1. When any digit higher than or equal to 2³ is 1, the load current is larger than or equal to 5 [A] even when the digits smaller than or equal to 2² have any numeric values. Thus, the output of the digit of 2⁰ and the output of the digit of 2² are input to an AND circuit 1, the output of the digit of 2¹ and the output of the digit of 2² are input to an AND circuit 2, and the outputs of the digits higher than or equal to the digit of 2³ are input to the OR circuit 1. The output of the AND circuit 1 and the output of the AND circuit 2 are input to the OR circuit 3, and the output of the OR circuit 1 and the output of the OR circuit 3 are input to the OR circuit 2.

The output of the OR circuit 2 is input to the counter 1, so the counter 1 is allowed to count a period of time when the load current is larger than or equal to 5 [A].

A circuit is constructed in the logic circuit 31 on the basis of a specified current (for example, 10 to 40 [A]) converted to a binary. The counter 2 is allowed to count a period of time when 10 [A] or larger load current is detected by the logic circuit 31. The counter 3 is allowed to count a period of time when 15 [A] or larger load current is detected by the logic circuit 31. The counter 4 is allowed to count a period of time when 30 [A] or larger load current is detected by the logic circuit 31. The counter 5 is allowed to count a period of time when 40 [A] or larger load current is detected.

When at least one of the counters 1 to 5 outputs the Hi signal, the OR circuit 30 outputs the Ili signal to the gate 131 of the MOS switch 13. Thus, the MOS switch 13 cuts off the load current. The operation procedure is similar to that of FIG. 8 according to the first example embodiment, so the flowchart is omitted.

In the present embodiment, as in the case of the first example embodiment, a plurality of operating points are allowed to be selectively defined by the A/D converter 19 and the logic circuit 31.

In the third example embodiment, the overcurrent protection circuit 100 that is able to set a similar number of operating points to that of the first embodiment with a smaller number of comparators as compared to the first embodiment by switching the specified currents of the comparators will be described.

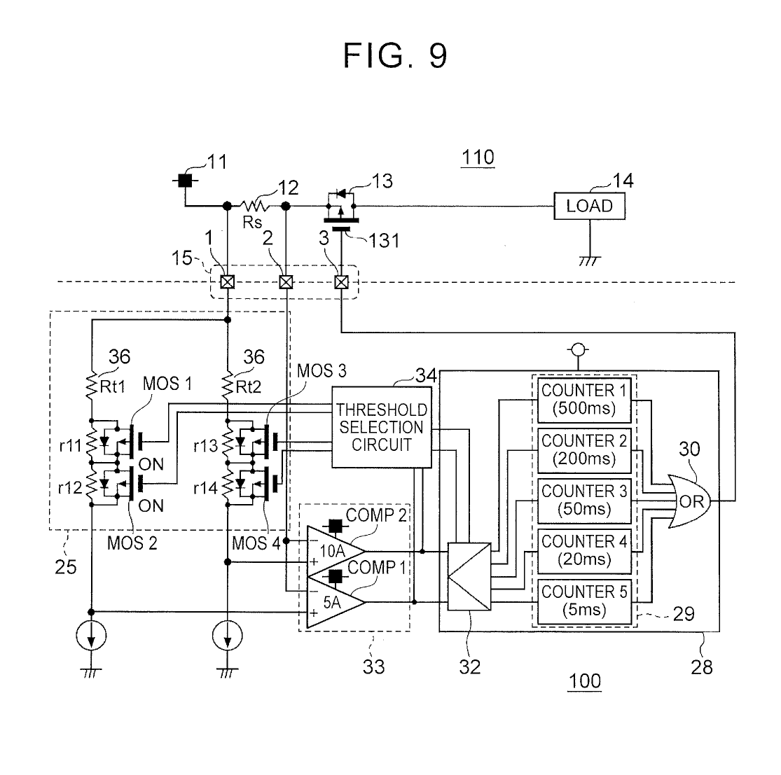

FIG. 9 shows an example of a configuration view of the overcurrent protection circuit 100 according to the present example embodiment. In FIG. 9, components indicated by like reference numerals as those of FIG. 5 exhibit similar functions, so only the major components of the present example embodiment may be specifically described.

The terminal 1 is connected to two parallel overcurrent threshold resistors 36. Hereinafter, the two overcurrent threshold resistors 36 are referred to as overcurrent threshold resistors. Rt1, Rt2 by using corresponding resistance values Rt1, Rt2. An overcurrent threshold selecting MOS 1 and an overcurrent threshold selecting MOS2 are connected in series with the overcurrent threshold resistor Rt1. An overcurrent threshold selecting MOS3 and an overcurrent threshold selecting MOS4 are connected in series with the overcurrent threshold resistor Rt2. The gates of the overcurrent threshold selecting MOST to the overcurrent threshold selecting MOS4 are connected to a threshold selection circuit 34, and the on/off state of each of the overcurrent threshold selecting MOS1 to the overcurrent threshold selecting MOS4 is controlled by the threshold selection circuit 34. The overcurrent threshold selecting MOS1 to the overcurrent threshold selecting MOS4 are turned on in an initial state.

End portions of the overcurrent threshold selecting MOS2 and overcurrent threshold selecting MOS4 are connected to a comparator 33 (hereinafter, referred to as the comparators 1, 2 for distinguishing from each other, and indicated by COMP1, COMP2 in FIG. 9). That is, the end portion of the overcurrent threshold selecting MOS2 is connected to the input terminal in+ of the comparator 1. The end portion of the overcurrent threshold selecting MOS4 is connected to the input terminal in+ of the comparator 2.

On the other hand, the voltage of the power supply 11 is stepped down by the shunt resistor 12 and then input to the input terminals in− of the comparators 1, 2. The comparators 1, 2 output the value of a positive power supply (that is the Hi-level signal) (turn on) in the case where “input terminal in+ input terminal in−”, and the comparators 1, 2 output zero [V] (turn off) in the case where “input terminal in+<input terminal in−”.

With the configuration shown in FIG. 9, six specified currents (thresholds) are allowed to be generated by the overcurrent threshold resistors Rt1, Rt2 and the four resistors r11 to r14 of the overcurrent threshold selecting MOS1 to the overcurrent threshold selecting MOS4. Hereinafter, generation of the specified currents 1 to 6 will be described.

When the overcurrent threshold selecting MOS1 to the overcurrent threshold selecting MOS4 are turned off, (i) the comparator 1 detects the specified current 1 that is defined by the overcurrent threshold resistor Rt1, and (ii) the comparator 2 detects the specified current 2 that is defined by the overcurrent threshold resistor Rt2.

When only the overcurrent threshold selecting MOS1 is turned on, (iii) the comparator 1 detects the specified current 3 that is defined by the overcurrent threshold resistor Rt1 and the resistor r11.

When only the overcurrent threshold selecting MOS1 and the overcurrent threshold selecting MOS3 are turned on, (iv) the comparator 2 detects the specified current 4 that is defined by the overcurrent threshold resistor Rt2 and the resistor r13.

When only the overcurrent threshold selecting MOS1, the overcurrent threshold selecting MOS2 and the overcurrent threshold selecting MOS3 are turned on, (v) the comparator 1 detects the specified current 5 that is defined by the overcurrent threshold resistor Rt1, the resistor r11 and the resistor r12.

When the overcurrent threshold selecting MOS1, the overcurrent threshold selecting MOS2, the overcurrent threshold selecting MOS3 and the overcurrent threshold selecting MOS4 are turned on, (v) the comparator 2 detects the specified current 6 that is defined by the overcurrent threshold resistor Rt2, the resistor r13 and the resistor r14.

In this way, the comparators 1, 2 are able to define different specified currents (three specified currents for each comparator) on the basis of the on/off state of each of the overcurrent threshold selecting MOS1 to the overcurrent threshold selecting MOS4. Hereinafter, as in the case of the first and second example embodiments, the specified current 1 is set to 5 [A], the specified current 2 is set to 10 [A], the specified current 3 is set to 15 [A], the specified current 4 is set to 30 [A] and the specified current 5 is set to 40 [A]. The specified current 6 is, for example, set to 50 [A]. The number of the overcurrent threshold selecting MOSs is one example, and may be five or more as long as the number of the overcurrent threshold selecting MOSs is any number larger than or equal to 1.

Next, the on/off state of each of the overcurrent threshold selecting MOS1 to the overcurrent threshold selecting MOS4 will be described. The threshold selection circuit 34 controls the on/off state of each of the overcurrent threshold selecting MOS1 to the overcurrent threshold selecting MOS4 by monitoring the outputs of the comparators 1, 2.

When the overcurrent threshold selecting MOS1 to the overcurrent threshold selecting MOS4 are turned off (the specified currents 1, 2 are defined) and both the comparators 1, 2 are turned on (when the load current larger than or equal to 10 [A] is detected), the threshold selection circuit 34 turns on the overcurrent threshold selecting MOS 1. Thus, the comparator 1 is able to detect the specified current 3 of 15 [A].

When only the overcurrent threshold selecting MOS1 is turned on and both the comparators 1, 2 are turned on (when the load current larger than or equal to 15 [A] is detected), the threshold selection circuit 34 turns on the overcurrent threshold selecting MOS3. Thus, the comparator 2 is able to detect the specified current 4 of 30 [A].

When only the overcurrent threshold selecting MOS1 and the overcurrent threshold selecting MOS3 are turned on and both the comparators 1, 2 are turned on (when the load current larger than or equal to 30 [A] is detected), the threshold selection circuit 34 turns on the overcurrent threshold selecting MOS2. Thus, the comparator 1 is able to detect the specified current 5 of 40 [A].

When only the overcurrent threshold selecting MOS1, the overcurrent threshold selecting MOS2 and the overcurrent threshold selecting MOS3 are turned on and both the comparators 1, 2 are turned on (when the load current larger than or equal to 40 [A] is detected), the threshold selection circuit 34 turns on the overcurrent threshold selecting MOS4. Thus, the comparator 2 is able to detect the specified current 6 of 50 [A].

In this way, the threshold selection circuit 34 turns on or off the overcurrent threshold selecting MOS1 to the overcurrent threshold selecting MOS4 on the basis of the value of the load current, so it is possible to detect three or more specified currents (which depends on the number of the overcurrent threshold selecting MOSs) with the use of the two comparators 1, 2.

Next, the outputs of the comparators 1, 2 and connection of the counters 1 to 6 will be described. In FIG. 9, the counter 6 is omitted. A digital circuit 28 according to the present example embodiment includes a demultiplexer 32, and switches the output of the comparator 1 to the counters 1, 3, 5 and the output of the comparator 2 to the counters 2, 4, 6. The demultiplexer 32 is controlled by the threshold selection circuit 34. That is, when the comparator 1 is operating at the specified current 1, the output of the comparator 1 is connected to the counter 1. Thus, when the comparator 1 turns on, the counter 1 starts counting a period of time. Similarly, when the comparator 2 defines the specified current 2, the output of the comparator 2 is connected to the counter 2. When the comparator 1 defines the specified current 3, the output of the comparator 1 is connected to the counters 1, 3. When the comparator 2 defines the specified current 4, the output of the comparator 2 is connected to the counters 2, 4. When the comparator 1 defines the specified current 5, the output of the comparator I is connected to the counters 1, 3, 5. When the comparator 2 defines the specified current 6, the output of the comparator 2 is connected to the counters 2, 4, 6.

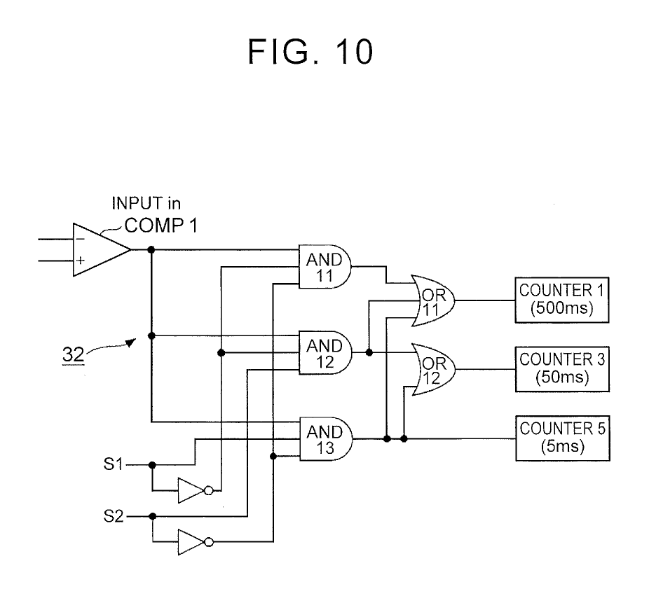

FIG. 10 is a view that shows an example of the demultiplexer 32. FIG. 10 shows the demultiplexer 32 that distributes the output of the comparator 1 among the counters 1, 3, 5, and the demultiplexer 32 of the comparator 2 is also similarly configured.

The demultiplexer 32 receives the output of the comparator 1 as an input in, and has three outputs. The input in and two selector signals S1, S2 are input to each of three AND circuits 11 to 13. The output of the AND circuit 11 is connected to the OR circuit 11, and the output of the OR circuit 11 is connected to the counter 1. The output of the AND circuit 12 is connected to the OR circuits 11, 12, and the output of the OR circuit 12 is connected to the counter 3. The output of the AND circuit 13 is connected to the OR circuits 11, 12 and the counter 5. The threshold selection circuit 34 selects one of the AND circuits 11 to 13 by controlling the selector signals S1, S2 as follows. When the AND circuit 11 is selected, S1=0 and S2=0 are selected. When the AND circuit 12 is selected, S1=0 and S2=1 are selected. When the AND circuit 13 is selected, S1=1 and S2=0 are selected. Because there are the OR circuits 11, 12, the AND circuit 11 is also selected when the AND circuit 12 is selected, and the AND circuits 11, 12 are also selected when the AND circuit 13 is selected.

Thus, the threshold selection circuit 34 sets “S1=0 and S2=0” when the overcurrent threshold selecting MOS1 to the overcurrent threshold selecting MOS4 are turned off (specified current 1=5 [A]). When only the overcurrent threshold selecting MOS1 is turned on (specified current 3=15 [A]), the threshold selection circuit 34 sets “S1=0 and S2=1”. When the overcurrent threshold selecting MOS1 and the overcurrent threshold selecting MOS2 are turned on (specified current 3=40 [A]), the threshold selection circuit 34 sets “S1=1 and S2=0”.

In this way, the demultiplexer 32 is controlled on the basis of the on/off state of each of the overcurrent threshold selecting MOS1 to the overcurrent threshold selecting MOS4, and it is possible to connect the outputs of the comparators 1, 2 to the counters 1 to 6 corresponding to the specified currents.

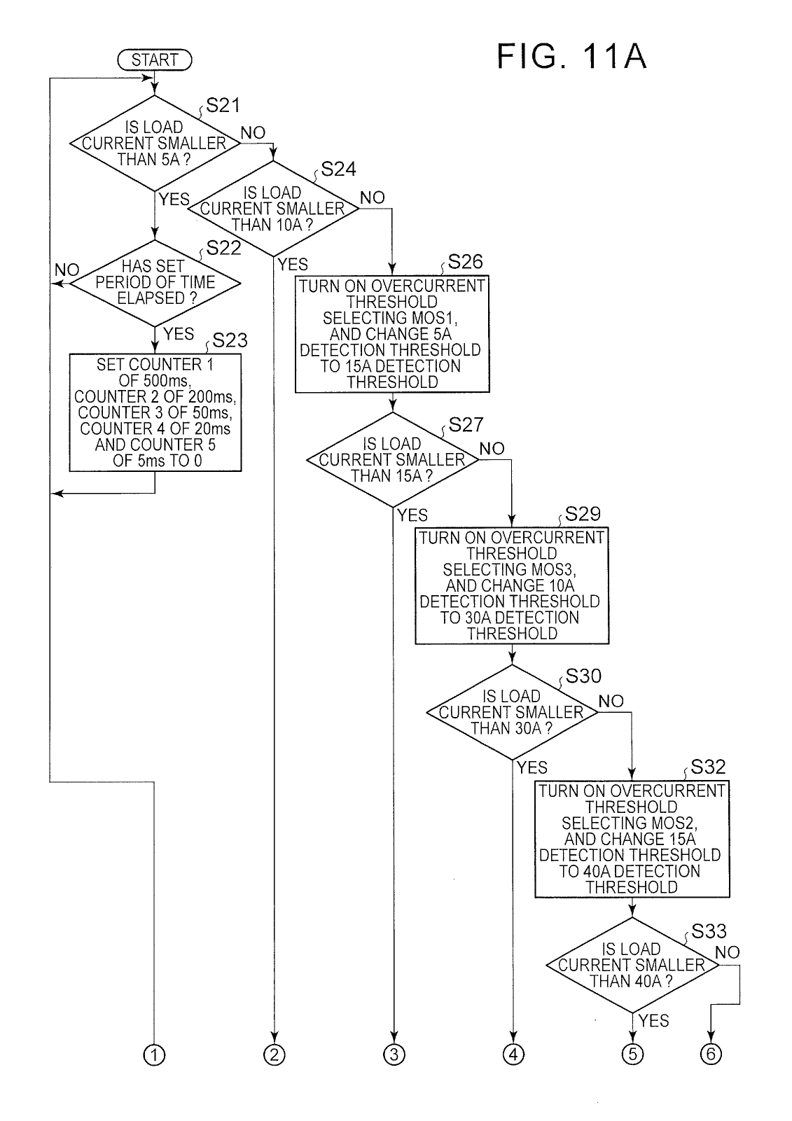

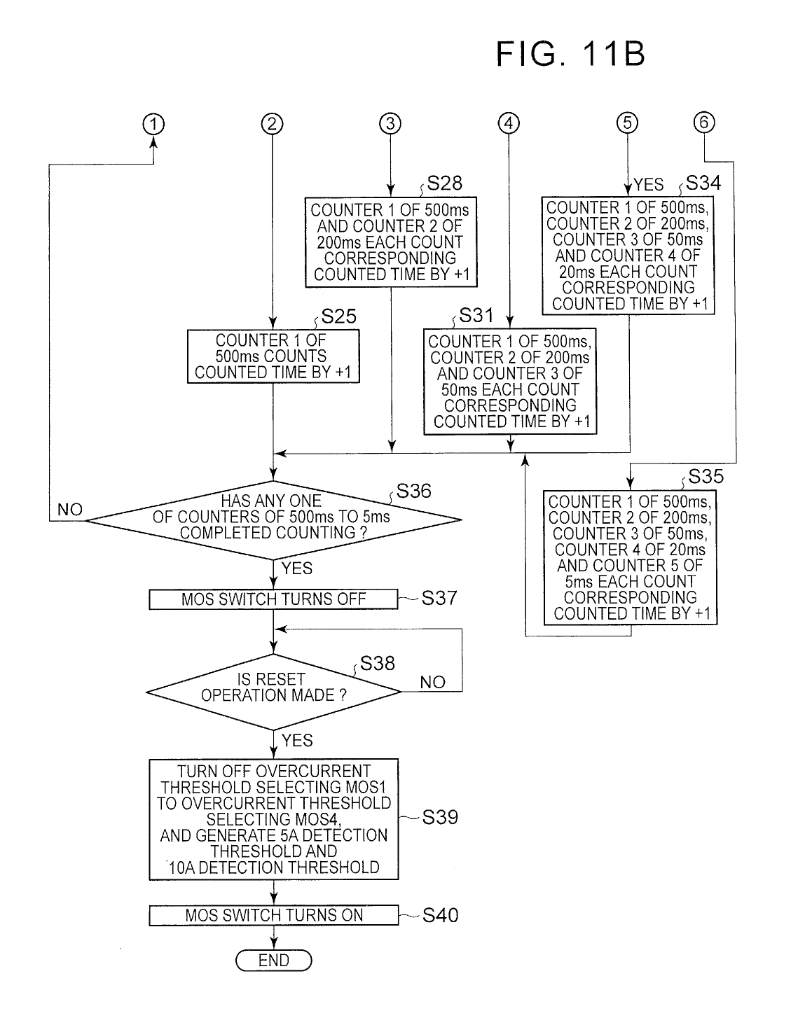

FIGS. 11A and 11B are an example of a view that illustrates operations of the overcurrent protection circuit 100 according to the present example embodiment in flowchart. In the case where the load current is smaller than 5 [A] (Yes in S21), when a set period of time has elapsed (Yes in S22), the digital circuit sets the counted times of the counters 1 to 5 to zero (S23). That is, no overcurrent is detected, so the counted times are initialized.

When the load current is larger than or equal to 5 [A] (No in S21) and the load current is smaller than 10 [A] (Yes in S24), the counter 1 counts a counted time by “+1” (S25).

When the load current is larger than or equal to 10 [A] (No in S24), the threshold selection circuit 34 turns on the overcurrent threshold selecting MOS1, and changes a 5 A detection threshold of the comparator 1 to a 15 A detection threshold (S26). That is, the threshold selection circuit 34 switches the specified current from the specified current 1 to the specified current 3.

Subsequently, when the load current is smaller than 15 [A] (Yes in S27), the counter 1 and the counter 2 each count a corresponding counted time by “+1” (S28).

When the load current is larger than or equal to 15 [A] (No in S27), the threshold selection circuit 34 turns on the overcurrent threshold selecting MOS3, and changes a 10 A detection threshold of the comparator 2 to a 30 A detection threshold (S29).

That is, the threshold selection circuit 34 switches the specified current from the specified current 2 to the specified current 4.

Subsequently, when the load current is smaller than 30 [A] (Yes in S30), the counters 1 to 3 each count a corresponding counted time by “+1” (S31).

When the load current is larger than or equal to 30 [A] (No in S30), the threshold selection circuit 34 turns on the overcurrent threshold selecting MOS2, and changes the 15 A detection threshold of the comparator 1 to a 40 A detection threshold (S32). That is, the threshold selection circuit 34 switches the specified current from the specified current 3 to the specified current 5.

Subsequently, when the load current is smaller than 40 [A] (Yes in S33), the counters 1 to 4 each count a corresponding counted time by “+1” (S34).

When the load current is larger than or equal to 40 [A] (No in S33), the counters 1 to 5 each count a corresponding counted time by “+1” (S34).

When at least any one of the counters 1 to 5 completes counting up to the corresponding specified time (Yes in S36), the MOS switch 13 turns off (S37). When any one of the counters 1 to 5 has not counted up to the corresponding specified time (No in S36), the overcurrent protection circuit 100 repeats counting process of S21 to S35.

When the IG switch is turned on or the microcomputer is reset (Yes in S38), the threshold selection circuit 34 turns off the overcurrent threshold selecting MOS1 to the overcurrent threshold selecting MOS4, and generates the 5 A detection threshold and the 10 A detection threshold (S39).

When the IG switch is turned on or the microcomputer is reset, the MOS switch 13 turns on (S40).

In the present example embodiment as in the case of the first example embodiment, it is possible to selectively define a plurality of operating points with the use of a further smaller number of comparators.

What is claimed is:

1. An overcurrent protection circuit that protects a load from an overcurrent, comprising:
a load current cutoff condition defining unit configured to define two or more load current cutoff conditions in each of which passage of a load current larger than or equal to a specified current for a specified time or longer is set as a condition for cutting off the load current;
a detection unit configured to detect passage of the load current larger than or equal to the specified current for the specified time or longer in at least one of the two or more load current cutoff conditions; and
a load current cutoff unit configured to cut off the load current when the detection unit detects that at least one of the load current cutoff conditions is satisfied.

2. The overcurrent protection circuit according to claim 1, wherein the detection unit is configured to count the specified time from zero again when the load current has been a value smaller than the specified current for a predetermined time or longer, before the detection unit detects passage of the load current larger than or equal to the specified current for the specified time or longer.

3. The overcurrent protection circuit according to claim 1, wherein the load current cutoff condition defining unit is configured to define a shorter specified time for the load current cutoff condition having a larger specified current.

4. The overcurrent protection circuit according to claim 1, further comprising a specified time storage unit configured to store the specified times in correspondence with a plurality of the specified currents in advance, wherein the specified time loaded from the specified time storage unit at the time of start-up of a device including the overcurrent protection circuit is configured to be set in the detection unit.

5. The overcurrent protection circuit according to claim 1, wherein the detection unit includes:
a current comparing unit provided for each specified current and including a first input terminal and a second input terminal, the first input terminal being connected to an upstream side of the detection unit for the load current via a reference resistor having a resistance value determined on the basis of a voltage of a power supply and a selected specified current, the second input terminal being connected to a downstream side of the detection unit; and
a plurality of time counting units each connected to the current comparing unit arranged in correspondence with the specified current, and
each current comparing unit is configured to cause the corresponding time counting unit to start counting a period of time when a current value at the first input terminal exceeds a current value at the second input terminal, and the load current cutoff unit is configured to cut off the load current when at least one of the plurality of time counting units has counted up to the corresponding preset specified time.

6. The overcurrent protection circuit according to claim 5, wherein
the detection unit is configured to count the specified time from zero again when the load current has been lower than the specified current for a predetermined period of time or longer before the detection unit detects passage of the load current larger than or equal to the specified current for the specified time or longer.

7. The overcurrent protection circuit according to claim 1, wherein
the detection unit includes an A/D conversion unit configured to convert a voltage between both ends of the detection unit for the load current to a digital signal; a plurality of time counting units arranged in correspondence with the specified currents; and when a fact that a value indicated by the digital signal is larger than or equal to the specified current is detected, a time counting control unit configured to cause any one of the time counting units, corresponding to the detected specified current, to start counting a period of time, and
the load current cutoff unit is configured to cut off the load current when at least one of the plurality of time counting units has counted a period of time up to the corresponding specified time set in advance.

8. The overcurrent protection circuit according to claim 7, wherein
the detection unit is configured to count the specified time from zero again when the load current has been lower than the specified current for a predetermined period of time or longer before the detection unit detects passage of the load current larger than or equal to the specified current for the specified time or longer.

9. The overcurrent protection circuit according to claim 1, wherein the detection unit includes:
a specified current output unit arranged between an upstream side of the detection unit for the load current and first and second current comparing units and configured to output a variable specified current;
the first current comparing unit configured to receive a first output of the specified current output unit and a downstream side of the detection unit as an input;
the second current comparing unit configured to receive a second output of the specified current output unit and the downstream side of the detection unit as an input;
a plurality of time counting units arranged in correspondence with the specified currents;
a notification destination switching unit configured to switch a destination one of the time counting units, to which a comparison result of the first current comparing unit and a comparison result of the second current comparing unit are notified; and
a circuit control unit configured to change the specified current that is output from the specified current output unit, on the basis of the comparison results of the first current comparing, unit and the second current comparing unit, and to control the destination one of the time counting units on the basis of the changed specified current, and
wherein the load current cutoff unit is configured to cut off the load current when at least one of the plurality of time counting units has counted a period of time up to the corresponding preset specified time.

10. The overcurrent protection circuit according to claim 9, wherein
the detection unit is configured to count the specified time from zero again when the load current has been lower than the specified current for a predetermined period of time or longer before the detection unit detects passage of the load current larger than or equal to the specified current for the specified time or longer.

11. An electronic control unit for a vehicle, comprising the overcurrent protection circuit according to claim 1.
